(19) United States
(12) Patent Application Publication
(10) Pub. No.: US 2009/0024306 A1
(43) Pub. Date: Jan. 22, 2009

(54) Fast Burn and High Compression Ratio Fuel Management System for Minimization of Ethanol Consumption in Ethanol Boosted Gasoline Engines

(76) Inventors: Leslie Bromberg, Sharon, MA (US); Paul Blumberg, Southfield, MI (US); Daniel R. Cohn, Cambridge, MA (US)

Correspondence Address: CHOATE, HALL & STEWART LLP, TWO INTERNATIONAL PLACE, BOSTON, MA, 02110, US

(21) Appl. No.: 12/167,534

(22) Filed: Jul. 3, 2008

Related U.S. Application Data
(60) Provisional application No. 60/948,753, filed on Jul. 10, 2007.

(51) Int. Cl. F02D 45/00

(52) U.S. Cl. 701/103; 701/111

(57) ABSTRACT

Fuel management system for a spark ignition gasoline engine. The system includes a gasoline engine, a source of gasoline, a source of a second liquid fuel and a means for introducing gasoline into the cylinders of the engine. Injectors directly inject the second liquid fuel into the cylinders of the engine and a fuel management control system controls injection of the second fuel into the cylinder so that it is provided in an amount needed to prevent knock as torque increases or other conditions require. A means for providing fast burn is provided.

This application claims priority to provisional application 60/948,753 filed Jul. 10, 2007, the contents of which are incorporated herein by reference in there entirety.

### BACKGROUND OF THE INVENTION

This invention relates to ethanol boosted gasoline engines and more particularly to a fuel management system for minimizing ethanol consumption.

U.S. Pat. Nos. 7,314,033 and 7,225,787 disclose the direct injection of ethanol into the cylinders of gasoline engines to suppress knock. The contents of these two patents are incorporated herein by reference. These patents teach a separate container for ethanol storage. Minimizing ethanol consumption is therefore important to reduce the inconvenience from having to refill an ethanol tank. The patents referenced above disclose the use of spark retard without fast burn and higher compression ratios.

It is known that modest spark retard from optimum spark timing (MBT), which is, in effect, combustion retard, has a significantly more pronounced effect on peak cylinder pressure and temperature than on the work output or efficiency of the engine cycle. This result stems from the fact that the work or efficiency are related to the integral of pressure with respect to volume, that is not as sensitive to the location of the combustion event in the cycle as compared to the peak pressure and temperature that are directly related to the conditions at a specific volume point in the cycle and are therefore extremely sensitive.

This phenomenon, through the use of modest combustion retard, allows for the control of engine knock, NOₓ formation in the cylinder, and a reduction in ethanol requirement in conjunction with ethanol boosted gasoline engine technology. This approach entails only a minimal loss in efficiency for modest amounts of retard up to approximately 5 to 15 crank angle degrees depending on the extent of fast burn and compression ratio increase.

### SUMMARY OF THE INVENTION

According to one aspect, the invention is a fuel management system for a spark ignition gasoline engine having a gasoline engine, a source of gasoline, and a source of a second liquid fuel. Apparatus is provided for introducing the gasoline into the cylinders of the engine and injectors are provided for direct injection of the second fuel into the cylinders of the engine. A fuel management control system controls injection of the second fuel into the cylinders so that it is provided in an amount needed to prevent knock as torque increases or as other conditions require. Means are provided for providing fast burn. In a preferred embodiment, the second liquid fuel is ethanol or its blends. Alternatively, the second fuel is methanol or its blends. It is preferred that the fast burn be characterized by a 10%-90% burn occurring in 15-20 crank angle degrees. Fast burn may be provided by charge motion. Fast burn may also be provided by increased temperature in an unburned zone of a fuel/air mixture zone that burns early in the cycle after spark plug firing. Dual ignition sites on either side of the cylinder may be selected. Fast burn can also be provided by a single high energy spark plug.

### BRIEF DESCRIPTION OF THE DRAWING

FIG. 1 is a block diagram illustrating one embodiment of the present invention.

### DESCRIPTION OF THE PREFERRED EMBODIMENT

In conjunction with ethanol boosted gasoline engine technology, it is disclosed herein to use fast burn combustion and higher compression ratio, typically characterized by 10%-90% burn times of 15-20 crank angle degrees and compression ratios of 13-14 in combination with appropriate combustion retard to reduce the amount of directly injected ethanol required to eliminate knock at any particular speed/load operating point requiring knock suppression. Typical 4-valve spark-ignited combustion chambers exhibit 10%-90% burn times of 30-40 crank angle degrees and compression ratios of 12 have been previously considered for an ethanol boosting system concept.

Fast burn and a higher compression ratio increase engine efficiency because both more of the fuel energy is released near top dead center (TDC) of the piston stroke and greater expansion work can be obtained from the engine. However, if fast burn and higher compression ratio are used at minimum spark advance for best torque timing (MBT), the net effect is to increase the tendency of the engine to knock as peak temperature and pressure increase with decreased burn time. Although the time at high temperature and pressure is decreased because of the fast combustion, the decrease in time is not sufficient to compensate for the increased temperature and pressure.

When fast burn and higher compression ratio are employed, the combustion timing is retarded to reduce peak pressure and temperature that will then have the effect of reducing the tendency to knock thereby requiring both less ethanol to suppress knock when it does occur and allowing higher output torque (or BMEP) before knock occurs and for a given amount of directly injected ethanol. Both the fast burn and the compression ratio increase serve to increase the efficiency at MBT combustion (spark) timing. However, fast burn decreases the ethanol requirement while increased compression ratio increases it. Using retard to decrease the ethanol fraction and the peak pressure results in a decrease in efficiency, but only by a small amount, as both the peak pressure and ethanol fraction are strong functions of retard but efficiency is only weakly dependent. These effects are additive, perhaps not linearly, thereby reducing the ethanol required to suppress knock by a greater amount than fast burn alone.

Therefore, employing a fast burn combustion chamber at a higher compression ratio allows combustion to be retarded to a point of equal efficiency of that of a typical or “slower” burn combustion chamber while, at the same time, reducing overall ethanol requirement. Alternatively, the negative effect of spark retard on efficiency can be eliminated by the use of fast combustion and higher compression ratio, for a similar ethanol additive requirement.

It should be pointed out that both methanol and ethanol have flame speeds that are higher than gasoline. Thus, when operating at relatively high concentrations of the second fuel, fast burn will be enhanced through the use of these secondary fuels.

Calculations have been performed using a model developed by the inventors based upon GT-Power engine simulation and the CHEMKIN codes at a speed of approximately 1,500 RPM and a load of 21 bar BMEP at a constant compression ratio of 13:1 to illustrate the effect. The conventional 10%-90% burn time was chosen to be 40 degrees of crank angle and a “fast burn” 10%-90% as 20 degrees of crank angle. MBT timing was identified for both cases and the fast burn combustion timing was retarded by 9.5 degrees (as determined by the point of 50% fuel burned) to a crank angle giving comparable efficiency to the slower burn. The predicted reduction in E85 requirement was very close to 50% or a factor of 2. These calculations were carried out in an engine of about 5 inches in bore, typical of a small class ⅞ truck diesel engine.

There are a number of ways of implementing fast burn in conjunction with ethanol boosted engine technology. The important general principles would be:

1. To have the unburned mixture (end-gas) as close to the intake valve side of the cylinder head so that it would remain as cool as possible.

2. To have the DI ethanol injected in the region of the end-gas for maximum effect.

The second effect has the simultaneous implications that the ethanol cools the outer region most likely to experience knock, while not cooling the inner region where the flame is initiated and most of the initial burn takes place. As flame velocity is a strong function of temperature (the laminar flame speed doubles approximately for every 200K increase in temperature), preventing the evaporative cooling of the central region could result in a significant increase in turbulent flame propagation (everything else being equal), at conditions of high ethanol fraction injection.

By adjusting the fuel mixture and the injection time it is possible to adjust both the ignition delay (0%-10% burn) as well as the combustion duration. Both ethanol and methanol have substantially faster flame speeds than gasoline. In addition, by adjusting the timing of injection it is possible to adjust the combustion duration. The most flexibility occurs when both the ethanol and the gasoline are directly injected, either through separate injectors or through the same injector with separate valves. The required alcohol/gasoline ratio to prevent knock when both are directly injected can be minimized further by use of fast burn.

Here early and late injection are used to indicate the effect in air-fuel mixture preparation. Early injection results in relatively homogeneous mixtures, while late injection results in stratified operation. During early injection substantial fuel evaporation and charge cooling occurs before inlet valve closing, thus resulting in admittance of more air. During late injection most fuel evaporation occurs after inlet valve closing and thus there is no increase in air due to the cooling process.

Late injection of alcohol decreases the net cooling, while early injection/evaporation allows for early cooling and increased air into the cylinder. Maximum cooling effect occurs when the ethanol vaporizes soon after inlet-valve closing, with cooling prior to substantial gas compression. Thus adjustment in injection timing can modify the combustion duration. The minimization of the alcohol consumption is a tradeoff between homogeneous operation with early injection but with maximum cooling effect, and late injection, with ethanol predominantly in the end-gas region but with less optimal cooling effect.

Additional optimization can be achieved by varying the amount of spark retard as a function of torque and speed during a drive cycle. In this way an optimal combination of use of the second fuel and the efficiency over a drive cycle can be obtained.

In large bore engines (greater than 100 mm diameter), fast burn could be accomplished by duel ignition sites on the exhaust valve side, coupled with a central direct injector whose spray would be angled toward the end-gas on the exhaust valve side of the cylinder. The engine would have to have a sufficient level of turbulence induced in the intake port or via a mask on the cylinder head to induce tumble in the combustion chamber. Swirl should be minimized or absent to avoid bringing the end-gas into contact with the hot exhaust valves.

In a smaller bore engine typical of automotive use, duel ignition can also be used. However, if it is not possible due to limited available space in the cylinder head, turbulence would have to be induced by a suitable device in the intake port, by the design of a suitable tumble intake port or by the use of an intake mask around the intake valve. Here again, the direct injector, probably situated near the periphery of the cylinder (exhaust side) should have a spray angled toward the end-gas for maximum knock suppression effort.

The combustion retard, through the use of appropriate spark timing could be varied as a function of the load and speed in order to obtain the optimum combination of drive cycle efficiency and minimum ethanol requirement.

Those skilled in the art will recognize that in addition to ethanol, the fast burn technology disclosed herein could be applied to other second fuels including, for example, methanol.

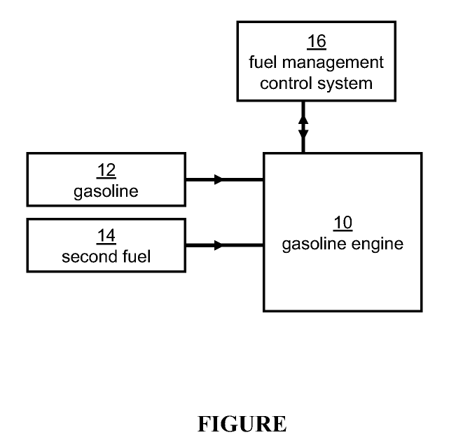

An embodiment of the present invention is illustrated in FIG. 1. In FIG. 1, a gasoline engine 10 receives gasoline from a gasoline source 12 and ethanol from a second fuel source 14. The introduction of gasoline from the gasoline source 12 and ethanol from the second fuel source 14 is controlled by a fuel management system 16 as described above.

It is recognized that modifications and variations of the invention will be apparent to those with ordinary skill in the art and it is intended that all such modifications and variations be included within the scope of the appended claims.

What is claimed is:

1. Fuel management system for a spark ignition gasoline engine comprising:
a gasoline engine;
a source of gasoline;
a source of a second liquid fuel;
a means for introducing gasoline into the cylinders of the engine;
injectors for direct injection of the second liquid fuel into the cylinders of the engine;
a fuel management control system for controlling injection of the second fuel into the cylinder so that it is provided in an amount needed to prevent knock as torque increases or other conditions require;
and a means for providing fast burn.

2. The fuel management system of claim 1 where the 10%-90% burn occurs in 15-20 crank angle degrees.

3. The fuel management system of claim 1 where the fast burn in the engine is provided by charge motion.

4. The fuel management system of claim 1 where the fast burn in the engine is provided by increased temperature in the unburned zone of air/fuel mixture zone that burns early in the cycle after the firing of the spark.

5. The fuel management system of claim 1 where there are dual ignition sites on either side of the cylinder.

6. The fuel management system of claim 1 where the direct injector is located in the center of the cylinder.

7. The fuel management system of claim 1 where the spray of the second fuel is aimed toward the end gas on the exhaust valve side of the cylinder and the injector is located near the periphery.

8. The fuel management system of claim 1 where the time of the direct injection of the second fuel is adjusted to minimize the ethanol consumption.

9. The fuel management system of claim 1 where turbulence is created at or near the intake port.

10. The fuel management system of claim 1 where combustion is retarded by means of spark retard relative to what it would be if fast burn were not employed.

11. The fuel management system of claim 9 where combustion, as measured by the 50% burn crank angle, is retarded using appropriate spark retard by an amount between 5 and 10 degrees.

12. The fuel management system of claims 1, 2, 8 or 9 where the amount of second fuel that is used is reduced when the fast burn is provided.

13. The fuel management system of claim 1 where the amount of combustion retard is varied as a function of load and speed by means of appropriate spark retard.

14. The fuel management system of claim 1 where the degree of combustion retard is chosen so as to optimize the combination of efficiency gain and minimization of the required amount of the second fluid fuel.

15. The fuel management system of claims 1-14 where the second fuel is ethanol or its blends.

16. The fuel management system of claims 1-14 where the second fuel is E85.

17. The fuel management system of claims 1-14 where the second fuel is methanol or its blends.

18. Fuel management system for a spark ignition gasoline engine comprising:
a gasoline engine of compression ratio between 13 and 14;
a source of a second liquid fuel;
a means for introducing gasoline into the cylinders of the engine;
injectors for direct injection of the second liquid fuel into the cylinder of the engine;
a fuel management control system for controlling injection of the second fuel into the cylinder so that it is provided in an amount needed to prevent knock as torque increases or other conditions require; and
a means for providing fast burn.

19. The fuel management system of claim 18 where the 10%-90% burn occurs in 15-20 crank angle degrees.

20. The fuel management system of claim 18 where the fast burn in the engine is provided by charge motion.

21. The fuel management system of claim 18 where the fast burn in the engine is provided by increased temperature in the unburned zone of air/fuel mixture zone that burns early in the cycle after the firing of the spark.

22. The fuel management system of claim 18 where there are dual ignition sites on either side of the cylinder.

23. The fuel management system of claim 18 where the direct injector is located in the center of the cylinder.

24. The fuel management system of claim 18 where the spray of the second fuel is aimed toward the end gas on the exhaust valve side of the cylinder.

25. The fuel management system of claim 18 where turbulence is created at or near the intake port.

26. The fuel management system of claim 18 where combustion is retarded by means of spark retard relative to what it would be if fast burn were not employed.

27. The fuel management system of claim 25 where combustion, as measured by the 50% burn crank angle, is retarded using appropriate spark retard by an amount between 5 and 15 degrees.

28. The fuel management system of claims 18, 19 or 25 where the amount of second fuel that is used is reduced when the fast burn is provided.

29. The fuel management system of claim 18 where the amount of combustion retard is varied as a function of load and speed by means of appropriate spark retard.

30. The fuel management system of claim 18 where the degree of combustion retard is chosen so as to optimize the combination of efficiency gain and minimization of the required amount of the second fluid fuel.

31. The fuel management system of claims 18-30 where the second fuel is ethanol or ethanol blends.

32. The fuel management system of claims 18-30 where the second fuel is E85.

33. The fuel management system of claims 18-30 where the second fuel is methanol or methanol blends.

34. A spark ignition gasoline engine where alcohol and gasoline are both directly injected and where the alcohol/gasoline ratio needed to prevent knock is reduced by using fast burn.

35. The spark ignition engine of claim 34 where a high energy spark plug is used to provide fast burn.
